(19) United States
(12) Patent Application Publication
(10) Pub. No.: US 2019/0065608 A1
(43) Pub. Date: Feb. 28, 2019

(54) QUERY INPUT RECEIVED AT MORE THAN ONE DEVICE

(71) Applicant: Lenovo (Singapore) Pte. Ltd., Singapore (SG)

(72) Inventors: Rod D. Waltermann, Rougemont, NC (US); Geoffrey Simon Bula, Apex, NC (US); Ya Zhang, Beijing (CN)

(21) Appl. No.: 15/689,665

(22) Filed: Aug. 29, 2017

(51) Int. Cl. G06F 17/30

(52) U.S. Cl. CPC G06F 17/30867; G06F 17/30991

(57) ABSTRACT

One embodiment provides a method, including: receiving, from at least one user, query input, wherein the query input is received at more than one information handling device; identifying an information handling device, from the more than one information handling device, for performing a function associated with the query input; and directing, to the identified information handling device, an output responsive to the query input. Other aspects are described and claimed.

### BACKGROUND

Many users use information handling devices (e.g., smart phones, mobile phones, tablets, personal computers, smart watches, etc.) to perform many different functions. Many of these functions include a user providing input to the device using one or more of a plurality of possible input modalities (e.g., mechanical key input, voice input, gesture input, etc.). For example, a user may use voice commands to provide input to a device having digital or virtual assistant software. The digital assistant may then perform a function associated with the input. For convenience, a user may have more than one device that can receive and process user input and subsequently perform a corresponding function associated with the user input. For example, a user may have both a smart phone and a dedicated digital assistant device that can both receive voice input and perform a function associated with the voice input.

### BRIEF SUMMARY

In summary, one aspect provides a method, comprising: receiving, from at least one user, query input, wherein the query input is received at more than one information handling device; identifying an information handling device, from the more than one information handling device, for performing a function associated with the query input; and directing, to the identified information handling device, an output responsive to the query input.

Another aspect provides an information handling device, comprising: a processor; a memory device that stores instructions executable by the processor to: receive, from at least one user, query input, wherein the query input is received at more than one information handling device; identify an information handling device, from the more than one information handling device, for performing a function associated with the query input; and direct, to the identified information handling device, an output responsive to the query input.

A further aspect provides a product, comprising: a storage device that stores code, the code being executable by a processor and comprising: code that receives, from at least one user, query input, wherein the query input is received at more than one information handling device; code that identifies an information handling device, from the more than one information handling device, for performing a function associated with the query input; and code that directs, to the identified information handling device, an output responsive to the query input.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method of identifying an information handling device from a plurality of devices to provide output responsive to receipt of query input.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Users frequently utilize devices to execute a variety of different commands or queries. One method of interacting with a device is to use digital or virtual assistant software employed on the device (e.g., Siri® for Apple®, Cortana® for Windows®, Alexa® for Amazon®, etc.). Digital assistants are able to provide outputs (e.g., audible outputs, visual outputs, etc.) that are responsive to a variety of different types of user inputs (e.g., voice inputs, etc.). Users may have more than one device that can receive and process inputs provided by a user. For example, a user may have a smart phone with digital assistant software and may also have a dedicated digital assistant device. As another example, a user may have a dedicated digital assistant device with receiving separate unit for each room of a house. Additionally, many different users may have their own devices that can receive and process inputs provided by a user. For example, in a group of friends, each friend may have their own device that can receive and process user inputs.

One problem with having so many devices that can process input is that it is possible for more than one device to receive the user input. For example, a user may provide input that can be “heard” or received by more than one unit. If each device has a different wake-word or action, the receipt of the user input by more than one device may be minimized because the user only provides a wake-word or action corresponding to a single unit. However, if multiple devices respond to or are activated by the same wake-word or action then each of the devices may attempt to process the input and perform a function associated with the received input. For example, if each of the devices is connected to a main device, for example, in the case of a main unit having multiple satellite receivers, each of devices responds to or is activated by the same wake-word or action. Such a scenario also occurs if one or more users have the same digital assistant software or technology, which are all activated by the same wake-word or action.

An additional problem with such a system is that the devices may interact with each other. For example, if both devices are activated through receipt of the user input, when one device provides a response to a query input, the second device may respond to the output of the first device. While such a scenario may be humorous in some situations, it may also be annoying, confusing, and frustrating in other situations. Additionally, getting the devices to stop interacting with each other may be difficult which may cause frustration for a user.

The conventional solution is to place the devices in such a manner that only one device can “hear” a command from any given location. However, such an arrangement may be difficult to achieve for many different reasons. For example, a user may not know the range of the device, and, therefore, may be unable to correctly identify how far apart the devices need to be. As another example, the layout of a room or building may not be conducive for placing devices in locations that ensure that only a single device can hear a command. Additionally, if a user carries a device that responds to the same activation action as another user's device, it may be impossible to keep the devices out of range of each other.

One solution to the problem of multiple user devices each responding to the same activation action is to allow users to select an activation action that is unique to the user. For example, one user may set one activation word and another user may set a different activation word. However, many users do not want to or do not know how to set the activation action to something other than the default activation action. Another solution is to use identification techniques to specifically identify a user. The user is then specifically associated with that device and the digital assistant software on that device, thereby allowing only that user to provide query input that generates a response by the digital assistant. However, this creates problems if more than one user uses a single device. Additionally, if another person wants to use the device but does not typically use the device, the device will not respond to the query input provided by that person.

Accordingly, an embodiment provides a method of identifying an information handling device from a plurality of devices to provide output responsive to receipt of query input. Particularly, an embodiment provides a method of identifying which information handling device out of a plurality of information handling devices that have received the same query input should perform an action in response to the received query input. The term query input will be used here throughout. However, it should be understood by one skilled in the art that query input does not necessarily mean a question to the digital assistant. For example, the user may provide a command, for example, “dim the lights”, for the assistant to process and complete. In other words, a query input includes an input provided to a digital assistant for processing, whether that is a question, command, or other type of input.

An embodiment may receive a query input from a user, where the query input is received at or “heard” by more than one information handling device, for example, the query input is received by two or more devices having digital or virtual assistant software. An embodiment may then identify which information handling device should perform a function associated with the query input. For example, an embodiment may determine which information handling device should analyze and/or process the query input or which device should provide the output responsive to the query input.

Identifying the information handling device that should perform a function may include identifying which device is closest to the source of the query input, which device received the strongest signal associated with the query input, which device received the query input first, and the like. One embodiment may identify the device based upon determining whether the query input was received from one or more sources. In other words, an embodiment may determine whether the query input that was received at each device was from a single source/single query or from multiple users/multiple queries. For example, in one embodiment, query input may be received from more than one user as in the case that more than one user provides query input to different devices connected to a single main device.

Identification of which device should perform a function may include different analysis techniques, for example, signal processing techniques (e.g., Fast Fourier Transforms (FFT), Time Frequency Domain (TFD), etc.), pattern processing techniques (e.g., distribution functions, Wigner Distribution functions, etc.), and the like. After identifying which information handling device should perform the function, the information handling device may perform the function and then direct or provide an output responsive to the query input. Such a method may assist a user in interacting with a digital assistant by preventing multiple devices from unnecessarily processing the query input.

The illustrated example embodiments will be best understood by reference to the figures. The following description is intended only by way of example, and simply illustrates certain example embodiments.

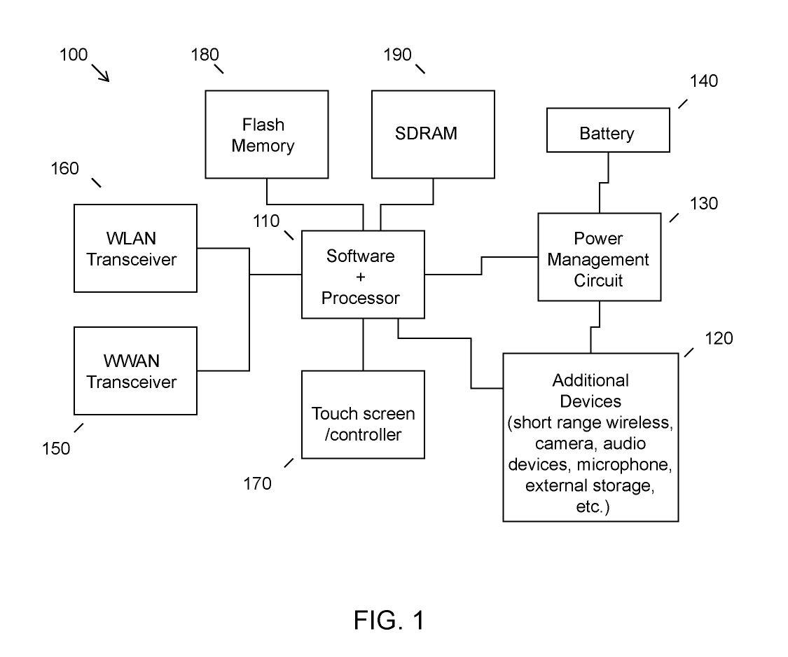

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, devices 120 are commonly included, e.g., an image sensor such as a camera. System 100 often includes a touch screen 170 for data input and display/rendering. System 100 also typically includes various memory devices, for example flash memory 180 and SDRAM 190.

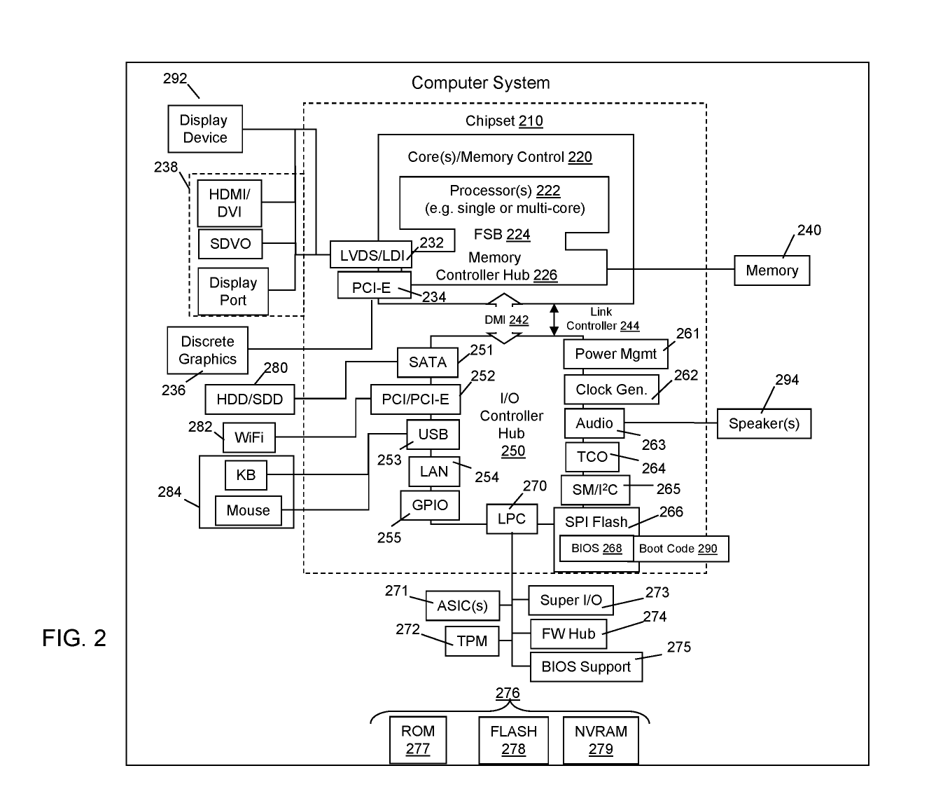

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a low voltage differential signaling (LVDS) interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, personal computer devices generally, and/or electronic devices which users may employ digital assistant software or which a user may use to interface or communicate with a digital assistant. For example, the circuitry outlined in FIG. 1 may be implemented in a tablet or smart phone embodiment, whereas the circuitry outlined in FIG. 2 may be implemented in a personal computer embodiment.

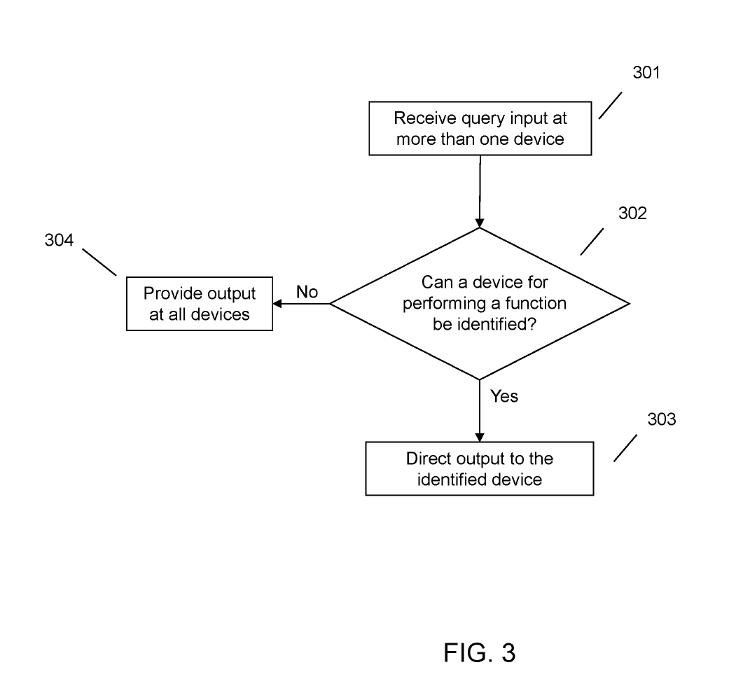

Referring now to FIG. 3, at 301, an embodiment may receive query input from at least one user. The query input may include an indication to initiate a conversational session with a user. A conversational session may be defined as a session with a digital assistant or other interactive application in which a user provides input, the digital assistant processes or analyzes the input, and the digital assistant then provides an output responsive to the input. A conversational session may include a single exchange of input and output, referred to herein as a single-turn conversational session, or multiple exchanges of input and output, referred to herein as a multi-turn interaction session.

In an embodiment, the indication to begin a conversational session may be associated with user-provided input. In an embodiment, the user-provided input indication may be a wakeup input or action provided by a user (e.g., one or more wakeup words or predetermined commands, a depression of a button for a predetermined length of time, a selection of a digital assistant icon, etc.). In an embodiment, the wakeup action may be provided prior to or in conjunction with user input. For example, a user may provide the vocal input, “Ok Surlexana, order a pizza.” In this scenario, “Ok Surlexana” is the wakeup word and upon identification of the wakeup word an embodiment may prime the system to listen for additional user input. Responsive to the identification of the wakeup action, an embodiment may initiate a conversational session. In another embodiment, the indication may not be associated with a wakeup action. For example, the system may simply “listen” to the user and determine when the user is providing input directed at the system. The conversational session may then be initiated when the system determines that the user input is directed to the system.

During the conversational session or in conjunction with receipt of the activation command, an embodiment may receive user input (e.g., voice input, touch input, etc.) including or associated with a user query or a user command, referred to herein as a query input, at a device (e.g., smart phone, smart speaker, tablet, laptop computer, etc.). In an embodiment, the device may employ digital assistant software capable of receiving and processing user input and subsequently providing output (e.g., audible output, textual output, visual output, etc.) corresponding or responsive to the user input. In an embodiment, the user input may be any input that requests the digital assistant to provide a response. For example, the user may ask the digital assistant a general question about a topic, the user may ask the digital assistant to provide instructions to assemble an object, the user may ask the digital assistant's opinion on a topic, the user may make a statement which allows a response, and the like.

The input may be received at an input device (e.g., physical keyboard, on-screen keyboard, audio capture device, image capture device, video capture device, etc.) and may be provided by any known method of providing input to an electronic device (e.g., touch input, text input, voice input, etc.). For simplicity purposes, the majority of the discussion herein will involve voice input that may be received at an input device (e.g., a microphone, a speech capture device, etc.) operatively coupled to a speech recognition device. However, it should be understood that generally any form of user input may be utilized. For example, the user may provide text input to the digital assistant, for example, through a chat assistant or instant messaging application.

In an embodiment, the input device may be an input device integral to the digital assistant device. For example, a smart phone may be disposed with a microphone capable of receiving voice input data. Alternatively, the input device may be disposed on another device and may transmit received input data to the digital assistant device. For example, voice input may be received at a smart speaker that may subsequently transmit the voice data to another device (e.g., to a user's smartphone for processing, etc.). Input data may be communicated from other sources to the digital assistant device via a wireless connection (e.g., using a BLUETOOTH connection, near field communication (NFC), wireless connection techniques, etc.), a wired connection (e.g., the device is coupled to another device or source, etc.), through a connected data storage system (e.g., via cloud storage, remote storage, local storage, network storage, etc.), and the like.

In an embodiment, the input device may be configured to continuously receive input data by maintaining the input device in an active state. The input device may, for example, continuously detect input data even when other sensors (e.g., cameras, light sensors, speakers, other microphones, etc.) associated with the digital assistant device are inactive. Alternatively, the input device may remain in an active state for a predetermined amount of time (e.g., 30 minutes, 1 hour, 2 hours, etc.). Subsequent to not receiving any input data during this predetermined time window, an embodiment may switch the input device to a power off state. The predetermined time window may be preconfigured by a manufacturer or, alternatively, may be configured and set by one or more users.

At 302 an embodiment may determine which one of the devices of the plurality of devices that received the user should perform a function associated with the query input. Identifying which device, from the more than one information handling device, should perform a function associated with the query input may use a variety of techniques as described in more detail below. It should be understood by one skilled in the art that these are merely examples and are not intended to be limiting.

One embodiment may use one or more analysis techniques to identify different characteristics regarding the relationship between the devices and the source of the query input. For example, an embodiment may use signal processing analysis techniques, (e.g., Fast Fourier Transforms (FFTs), Time Frequency Domain (TFD) analysis, etc.), pattern matching analysis techniques (e.g., Wigner distribution functions, distribution functions, etc.), and the like, to identify characteristics. In one embodiment identifying a relationship between the devices and the source of the query input may include identifying a distance between the device(s) and the source of the query input. In other words, an embodiment may identify which of the plurality of devices is closest to the source of the query input, or the user who is providing the query input. To determine which device is closest, an embodiment may use different analysis techniques. For example, an embodiment may use FFTs to help identify a difference in distance between the source and one or more devices.

An embodiment may then only process the query input at the device closest to the user and ignore the query input at the remaining devices. Processing the query input may be completed at the device itself or may be completed at another device operatively coupled to the device. For example, the device may send the query input and instructions to process the query input at another device, for example, a central device or a cloud device. Nonetheless, the identified device will be the device whose signal is selected for processing and also the device at which output will be provided.

As another example, an embodiment may determine a time difference between receipt of the query input at each of the devices. In other words, a closer device may receive the query input at a time sooner than a device that is further from the source. This time difference can then be used to identify a distance between the device(s) and the query input source. Alternatively, an embodiment may simply determine the time difference between receipt of the query input at each of the devices and not identify a particular distance from the query input source and the device(s). In other words, an embodiment may simply determine which device received the query input signal first.

One analysis technique that may be useful in determining which signal was received first is a TFD analysis. As should be understood by one skilled in the art, while one analysis technique may be used as an example, other analysis techniques may be used. Additionally, an analysis technique used as an example for one determination may also be useful in other determinations. In other words, as an example, while the TFD analysis technique is used in conjunction with determining which signal is received first, the TFD analysis technique may also be useful in determining a distance between the device and the query input source. An embodiment may then process the query input at the device that first received the query input and ignore the query input at the remaining devices.

In one embodiment identifying a characteristic may include determining which information handling device received the strongest signal comprising the query input. For example, due to distance, the audible input received at one device may be louder or stronger than the audible input received at another device. As another example, due to a source direction of the query input, one device may receive a stronger signal than another device. For example, if a user is facing a first device and not another device, the first device may receive a stronger signal than the other device regardless of the distance from the user to the device(s). An embodiment may then only process the query input at the device receiving the strongest signal and ignore the query input at the remaining devices.

One embodiment may identify a device by making a comparison between the query input or signals of the query input received at each of the devices. This comparison may identify whether the query input received at each of the devices is the same query input or different query input or if the query input was provided by a single person or multiple people. For example, the comparison may be used to determine if a single person provided query that was received at two separate devices or if multiple people are each providing query input to separate devices. One method for determining if the query input is the same query input received at more than one device is to complete a pattern matching. For example, an embodiment may use a distribution function or Wigner distribution function to determine if the patterns of the signals received at each of the devices is the same or different. An embodiment may also perform filtering on the signals before comparing the patterns. For example, an embodiment may first perform a time matching filtering to match the start time of the signals to account for the signals being received at each of the devices at slightly different times. The pattern matching may include matching characteristics of the audible input, for example, frequency, cadence, pitch, or the like.

If an embodiment determines that the query input received at each of the devices is the same query input, an embodiment may ignore the query input received at one or more of the devices and only process the query input received at one of the devices. However, if an embodiment determines that the query input received at each of the devices is different query input or provided by different people, even if it is the same input, an embodiment may process the query input received at all the devices which have received the query input.

An embodiment may also use additional information to determine which device should be used. For example, an embodiment may use images, signal strength of associated devices as compared to the receiving devices, and the like, to identify which device should be used as the output device. Any combination of the above techniques for identifying the device can be used. Additionally, other techniques are contemplated and possible.

If a device cannot be identified from the plurality of devices at 302, an embodiment may provide output at all the devices at 304, for example, as in conventional systems. Alternatively, an embodiment may request input from the user requesting the user to provide additional input so that the analysis can be performed again or requesting the user identify which device should process the input. If, however, a device can be identified from the plurality of devices at 302, an embodiment may direct an output responsive to the query input to the identified device at 303.

In an embodiment, the digital assistant device, or another device associated with the digital assistant device, may direct an output responsive to the query input to the identified device. Directing the output may include performing or providing the output function at the device itself or may include sending instructions to a different device to perform a function responsive to the query input. For example, in one embodiment the digital assistant software may be located at a central device having multiple satellite devices. The central device may process the query input, determine which device should provide the output, and then provide instructions to that device to provide the output. Alternatively, each device that receives the query input may perform its own analysis and determine whether it should perform a function associated with the query input. In the event that the device determines that it should perform a function, the device may direct itself to perform the output function. Directing the output responsive to the query input may also include directing another device to perform a task. For example, if the query input is to dim the lights, a device having digital assistant software may direct a device operatively coupled to the lights to dim the lights.

In an embodiment, the output function may comprise the provision of output, provision of instructions to perform a task, the performance of a task, a combination thereof, and the like. For example, the digital assistant may provide an audible response to a question posed by the user, dim the lights in response to a command to do so, send instructions to another device to dim the lights, provide an audible output indicating that a pizza has been ordered in response to a command to do so, and the like. Regarding the provision of output, the output may be audio output, visual output, a combination thereof, or the like. In an embodiment, audible output may be provided through a speaker, another output device, and the like. In an embodiment, visual output may be provided through a display screen, another display device, and the like.

In an embodiment, the output device may be integral to the speech recognition device or may be located on another device. In the case of the latter, the output device may be connected via a wireless or wired connection to the digital assistant device. For example, a smart phone may provide instructions to provide audible output through an operatively coupled smart speaker. Regarding the performance of a task, the task may be virtually any task that is capable of being executed by one or more devices. For example, an embodiment may dim the lights in the room, change a television channel, commence a financial transaction, or the like.

The various embodiments described herein thus represent a technical improvement to conventional digital assistant systems. Using the techniques described herein, a user can provide query input that is only processed by a single device even if multiple devices receive the query input. As described herein the systems and methods identify which device should process the query input, even if the query input is received by multiple devices. Such techniques enable a more efficient digital assistant system that does not unnecessarily process query input in multiple instances and use extra processing resources and take additional time to provide an output responsive to the query input. Additionally, the techniques as described herein prevent devices from interacting with each other due to the receipt of query input that can be received by both devices.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
receiving, from at least one user, query input, wherein the query input is received at more than one information handling device;
identifying an information handling device, from the more than one information handling device, for performing a function associated with the query input; and
directing, to the identified information handling device, an output responsive to the query input.

2. The method of claim 1, wherein the identifying an information handling device comprises identifying the information handling device located closest to a source of the query input.

3. The method of claim 1, wherein the identifying an information handling device comprises identifying the information handling device having received a strongest signal comprising the query input.

4. The method of claim 1, wherein the identifying an information handling device comprises identifying the information handling device that received the query input first.

5. The method of claim 1, wherein the identifying an information handling device comprises determining if the query input received at the more than one information handling device comprises the same query input.

6. The method of claim 1, wherein the identifying an information handling device comprises determining that the query input received at the more than one information handling device comprises different query input.

7. The method of claim 1, wherein the identifying an information handling device comprises determining that the query input received at the more than one information handling device comprises query input provided by more than one user.

8. The method of claim 7, wherein the identifying an information handling device further comprises identifying an information handling device to process each of the query inputs.

9. The method of claim 1, wherein the identifying an information handling device comprises using at least one analysis technique selected from: Fast Fourier Transform, Time Frequency Domain, and Wigner Distribution.

10. The method of claim 1, wherein the directing an output comprises processing the query input.

11. An information handling device, comprising:
a processor;
a memory device that stores instructions executable by the processor to:
receive, from at least one user, query input, wherein the query input is received at more than one information handling device;
identify an information handling device, from the more than one information handling device, for performing a function associated with the query input; and
direct, to the identified information handling device, an output responsive to the query input.

12. The information handling device of claim 11, wherein the instructions executable by the processor to identify an information handling device comprise instructions executable by the processor to identify the information handling device located closest to a source of the query input.

13. The information handling device of claim 11, the instructions executable by the processor to identify an information handling device comprise instructions executable by the processor to identify the information handling device having received a strongest signal comprising the query input.

14. The information handling device of claim 11, wherein the instructions executable by the processor to identify an information handling device comprise instructions executable by the processor to identify the information handling device that received the query input first.

15. The information handling device of claim 11, wherein the instructions executable by the processor to identify an information handling device comprise instructions executable by the processor to determine if the query input received at the more than one information handling device comprises the same query input.

16. The information handling device of claim 11, the instructions executable by the processor to identify an information handling device comprise instructions executable by the processor to determine that the query input received at the more than one information handling device comprises different query input.

17. The information handling device of claim 11, wherein the instructions executable by the processor to identify an information handling device comprise instructions executable by the processor to determine that the query input received at the more than one information handling device comprises query input provided by more than one user.

18. The information handling device of claim 17, the instructions executable by the processor to identify an information handling device further comprise instructions executable by the processor to identify an information handling device to process each of the query inputs.

19. The information handling device of claim 11, wherein the instructions executable by the processor to identify an information handling device comprise using at least one analysis technique selected from: Fast Fourier Transform, Time Frequency Domain, and Wigner Distribution.

20. A product, comprising:
a storage device that stores code, the code being executable by a processor and comprising:
code that receives, from at least one user, query input, wherein the query input is received at more than one information handling device;
code that identifies an information handling device, from the more than one information handling device, for performing a function associated with the query input; and
code that directs, to the identified information handling device, an output responsive to the query input.
